(19) United States
(12) Patent Application Publication
(10) Pub. No.: US 2010/0180591 A1
(43) Pub. Date: Jul. 22, 2010

(54) SUPERCHARGED DIESEL ENGINES

(76) Inventors: Richard Charles Elliot Cornwell, West Sussex (GB); Brian Gorman Cooper, East Sussex (GB); Edward Thomas Bower, West Sussex (GB)

Correspondence Address: ABELMAN, FRAYNE & SCHWAB, 666 THIRD AVENUE, 10TH FLOOR, NEW YORK, NY, 10017, US

(21) Appl. No.: 11/993,203

(22) PCT Filed: Jun. 16, 2006
(86) PCT No.: PCT/GB06/02210

§ 371 Date: Oct. 28, 2008

(30) Foreign Application Priority Data
Jun. 20, 2005 (GB) 0512543.0
Nov. 7, 2005 (GB) 0522676.6

(51) Int. Cl. F02D 23/00; F02B 33/44; F01N 3/00

(52) U.S. Cl. 60/602; 60/611; 60/605.2; 60/274

(57) ABSTRACT

A diesel engine comprises a plurality of cylinders (2), an inlet duct (4), an exhaust duct (6), a turbocharger (8, 10) and a supercharger (14), the turbocharger being of variable output type and including a turbine (8) in the exhaust duct (6) and a supercharger (14) being of variable output type and situated in the inlet duct (4) between the compressor wheel (10) and the cylinders and being electrically driven or mechanically driven by the engine. The engine also includes a first sensor (25) arranged to produce a signal indicative of the speed of the engine, a second sensor (27) arranged to produce a signal indicative of the load to which the engine is subjected and a third sensor (26) arranged to produce a signal indicative of the pressure in the inlet duct (4) downstream of the supercharger (14). The sensors (25, 27, 26) are connected to a controller (29) which is also connected to the turbocharger and the supercharger and is arranged to vary their output independently. The controller (29) is programmed to determine the desired value of the pressure in the inlet duct (4) downstream of the supercharger (14) and to compare this with the actual value of the pressure and, in the event of there being a difference, to adjust the output of the supercharger and/or turbocharger until there is substantially no difference. The controller (29) is also programmed, if a higher pressure is required in the inlet duct (4), to preferentially increase the output of the turbocharger, subject to the pressure in the exhaust duct (6) not exceeding a predetermined value and, if a lower pressure is required in the inlet duct, preferentially to decrease the output of the supercharger.

The present invention relates to supercharged diesel engines.

It is well known to increase the power output of a diesel engine by providing it with a turbocharger including a turbine situated in the exhaust duct and connected to a compressor wheel or impeller situated in the inlet duct. Rotation of the turbine by the exhaust gas rotates the compressor wheel which boosts the engine inlet pressure and thus results in a greater amount of air being induced into the engine. It is also well known to provide such engines with a supercharger, namely a pump of any of a variety of types driven by an electric motor or driven mechanically from the crank shaft of the engine, for the purpose of boosting the inlet duct pressure.

The disadvantages of both these devices are also well known. Thus the speed of a turbocharger turbine is related to the cube of the speed of the exhaust gases and this means in practice that a turbocharger is not capable of producing any very significant boost pressure at low engine speeds. Furthermore, turbochargers suffer from so called “turbo lag”, which means that after the accelerator pedal of an automotive engine has been depressed, there is a delay of several seconds before the engine speed picks up sufficiently for the turbocharger to begin to produce a significant boost pressure. The mechanical input power provided to the compressor wheel of a turbocharger is effectively “free” in that it is extracted from the high speed exhaust gases. However, if it should be attempted to drive the turbocharger faster (to produce greater levels of boost) than a speed predetermined by the speed of the exhaust gases, for example by closing the wastegate or variable turbine vanes, the back pressure in the exhaust duct rises unacceptably and this decreases the efficiency of the engine by increasing its fuel consumption. The power input to a supercharger, on the other hand, is derived directly or indirectly from the crank shaft or electrically via an alternator and thus represents a significant power drain on the engine. Furthermore, large capacity superchargers can be extremely expensive.

Engines are known with two turbochargers in series, one being substantially larger than the other. The smaller turbocharger is able to produce significant boost pressure at relatively low engine speeds but would be choked by high flow rates of exhaust gas at higher engine speeds and would cause an obstruction to the engine exhaust. The smaller turbocharger is therefore provided with a bypass passage whereby turbocharging is effected by the smaller turbocharger at lower engine speeds and the larger turbocharger at higher engine speeds. However, such twin charging systems suffer from a number of disadvantages not least due to the fact that the available boost pressure is still inherently related to the pressure in the exhaust duct.

It is therefore the object of the present invention to provide a diesel engine of twin charged type, that is to say with two charging devices, which combines the known advantages of both turbochargers and superchargers but does not suffer from their disadvantages.

It is well known in both diesel and gasoline engines to re-circulate a quantity of exhaust gas back from the exhaust duct to the inlet duct under certain engine conditions because it is found that mixing this re-circulated exhaust gas with incoming air reduces the amount of available oxygen for combustion and thus lowers the peak temperature of the combustion. This therefore limits the generation of nitrogen oxides. Exhaust gas is typically re-circulated via an exhaust gas re-circulation (EGR) duct extending between the exhaust duct and the inlet duct. The EGR duct is typically controlled by an EGR valve to regulate the gas flow. However, one of the most important factors determining the rate of flow of exhaust gas through the EGR duct is the pressure differential between its ends and it is not generally possible to control this, without affecting other controlled parameters of the engine e.g. boost pressure or fuel consumption. The flow of re-circulated exhaust gas is therefore sometimes constrained by the need to simultaneously optimise boost performance whilst maintaining minimal fuel consumption, and it is a further object of the present invention to provide a diesel engine with means which permit the ready adjustment of the rate of flow of exhaust gas through an EGR duct, with a degree of independence from boost system performance and fuel consumption.

According to the present invention, there is provided a diesel engine comprising one or more cylinders, an inlet duct, an exhaust duct, a turbocharger and a supercharger, the turbocharger being of variable output type and including a turbine situated in the exhaust duct and coupled to a compressor wheel situated in the inlet duct, the supercharger being of variable output type and situated in the inlet duct between the compressor wheel and the cylinder(s) and being electrically driven or mechanically driven by the engine, the engine further including a first sensor arranged to produce a signal indicative of the speed of the engine, a second sensor arranged to produce a signal indicative of the load to which the engine is subjected and a third sensor arranged to produce a signal indicative of the pressure in the inlet duct downstream of the supercharger, the sensors being connected to a controller which is also connected to the turbocharger and the supercharger and is arranged to vary their output independently, the controller being programmed to determine the desired value of the pressure in the inlet duct downstream of the supercharger and to compare this with the actual value of the pressure and, in the event of there being a difference, to adjust the output of the supercharger and/or turbocharger until there is substantially no difference, the controller being further programmed, if a higher pressure is required in the inlet duct, to preferentially increase output of the turbocharger, subject to the pressure in the exhaust duct not exceeding a predetermined value and, if a lower pressure is required in the inlet duct, preferentially to decrease the output of the supercharger.

Thus the engine in accordance with the invention includes a turbocharger which is the variable output type, eg. includes a wastegate and/or adjustable pitch vanes, and a supercharger, which is preferably of substantially smaller capacity than the turbocharger and is also of variable output type. Numerous different types of supercharger are known and these therefore need not be described. The engine includes, as is usual, includes first and second sensors arranged to produce signals indicative of the speed of the engine and of engine load, respectively. It also includes a third sensor arranged to produce a signal indicative of the pressure in the inlet duct downstream of the supercharger. These sensors are connected to an electronic controller, which in practice constitutes at least a proportion of the engine management system with which most automotive engines are now provided. This controller is also connected to the turbocharger and the supercharger and can vary their output independently. The value of the desired boost pressure in the inlet duct is determined by the controller taking account of, amongst other things, engine speed and engine load. This desired boost pressure is compared with the actual value of the pressure in the inlet duct and if there is a difference the speed of the supercharger and/or turbocharger is altered to eliminate that difference. Since the input power to the turbocharger is effectively “free” (i.e. using energy which would otherwise be wasted), the controller is programmed to preferentially increase the output to the turbocharger in the event that a higher boost pressure is required. This means that, if practicable, it is the speed of the turbocharger that is increased. However, if the engine speed is very low, the turbocharger may be incapable of producing the boost pressure that is desired in an acceptable period of time and the controller then increases the speed of the supercharger. Since the engine will become inefficient, that is to say consume a greater amount of fuel, if the back pressure in the exhaust duct rises above a predetermined level, the controller is also programmed to ensure that the turbocharger is not operated such that the pressure in the exhaust duct does not rise above a predetermined value. Once the pressure in the exhaust duct has reached the predetermined value, the controller will not permit any further increase in the speed of the turbocharger and thus if an increased boost pressure is required, the controller is programmed to achieve this by increasing the speed of the supercharger. Similarly, if the controller determines that the boost pressure should be reduced, it is programmed to preferentially decrease the outlook of the supercharger so as to reduce the mechanical drain on the engine. However, at higher engine speeds, the supercharger may not be operating at all and in this event, the controller will of course decrease the speed of the turbocharger, e.g. by opening the wastegate and/or by adjusting the angle of the vanes of the turbine.

It is therefore essential that the controller knows what the exhaust pressure in the exhaust duct is at all times. This can be achieved by mapping the exhaust duct pressure at all possible ranges of operating parameters and storing this map in the controller. The controller will know the speed and load of the inlet and the boost pressure and the speed of the turbocharger and supercharger and these values will uniquely define the exhaust duct pressure. Alternatively, the engine may include a fourth sensor arranged to produce a signal indicative of the pressure in the exhaust duct upstream of the turbine. The controller will then compare the actual value of the exhaust duct pressure with the predetermined maximum pressure and make adjustments to the speed of the turbocharger and/or supercharger on the basis of this comparison.

In one embodiment of the invention, the engine further includes an exhaust gas re-circulation (EGR) duct communicating with the exhaust duct at a position between the particulate filter and the turbine and with the inlet duct and an exhaust purifying device situated in the exhaust gas pathway between the cylinders and the position at which the EGR duct communicates with the inlet duct and further includes sensor means arranged to produce a signal indicative of the rate of flow of exhaust gas through the EGR duct, the sensor means being connected to the controller, the controller being programmed to determine the desired flow rate of exhaust gas into the inlet duct and to compare this with the actual value of the flow rate and, in the event of there being a difference, to adjust the output of the supercharger and/or turbocharger until there is substantially no difference.

Indeed, it is believed that this embodiment and the associated method that is referred to below are novel per se and find application without certain of the features referred to above.

Thus according to a further aspect of the present invention a diesel engine comprises one or more cylinders, an inlet duct, an exhaust duct, a turbocharger and a supercharger, the turbocharger being of variable output type and including a turbine situated in the exhaust duct and coupled to a compressor wheel situated in the inlet duct, the supercharger being of variable output type and situated in the inlet duct between the compressor wheel and the cylinder(s) and being electrically driven or mechanically driven by the engine, the engine including an exhaust gas re-circulation (EGR) duct communicating with the exhaust duct at a position between the purifying means and the turbine and gas purifying means, such as a particulate filter, situated in the exhaust gas pathway between the cylinders and the position at which the EGR duct communicates with the inlet duct and further including a first sensor arranged to produce a signal indicative of the speed of the engine, a second sensor arranged to produce a signal indicative of the load to which the engine is subjected and sensor means arranged to produce a signal indicative of the rate of flow of exhaust gas through the EGR duct, the two sensors and the sensor means being connected to a controller, which is also connected to the turbocharger and the supercharger and is arranged to vary their output independently, the controller being programmed to determine the desired flow rate of flow of exhaust gas into the inlet duct and to compare this with the actual value of the flow rate and, in the event of there being a difference, to adjust the output of the supercharger and/or turbocharger until there is substantially no difference.

Thus this aspect of the invention is dependent upon the fact that one of the primary factors affecting the rate of flow of exhaust gas through the EGR duct is the pressure differential between its ends. The flow rate may be altered by altering this pressure differential and it will be appreciated that increasing the output of the turbocharger will increase the pressure in the exhaust duct, that is to say that the pressure at the inlet end of the EGR duct, and in fact, if the downstream end of the EGR duct, communicates as is preferred, with the inlet duct at a position between the compressor wheel and the supercharger, the pressure at the downstream end of the EGR duct may be decreased by increasing the output speed of the supercharger. Accordingly, the rate of supply of re-circulated exhaust gas to the engine may be controlled very precisely by controlling the output of the turbocharger and supercharger and this control does not interfere with that referred to above relating to controlling the boost pressure of the engine. Thus if the EGR duct communicates, as is preferred, with the inlet duct at a point between the turbocharger and supercharger, the pressure at the downstream end of the EGR duct, i.e. upstream of the supercharger, may be controlled independently of the boost pressure, i.e. the pressure downstream of the supercharger, by appropriate control of the speeds of the turbocharger and supercharger. Similar comments apply if the EGR duct communicates with the inlet duct upstream of the turbocharger. If, however, the EGR duct communicates with the inlet duct at a position downstream of the supercharger, changes in the boost pressure will inherently also result in a change in the rate of EGR delivery. In order to make the boost pressure and EGR supply truly independent, it may be desirable in this case to provide a pump in the EGR duct controlled by the controller. The re-circulated exhaust gas is also substantially clean because it flows through the particulate filter and will thus not contaminate the turbocharger or supercharger. The particulate filter will be positioned in the EGR duct or in the exhaust duct at a position upstream of that at which the EGR duct communicates with it.

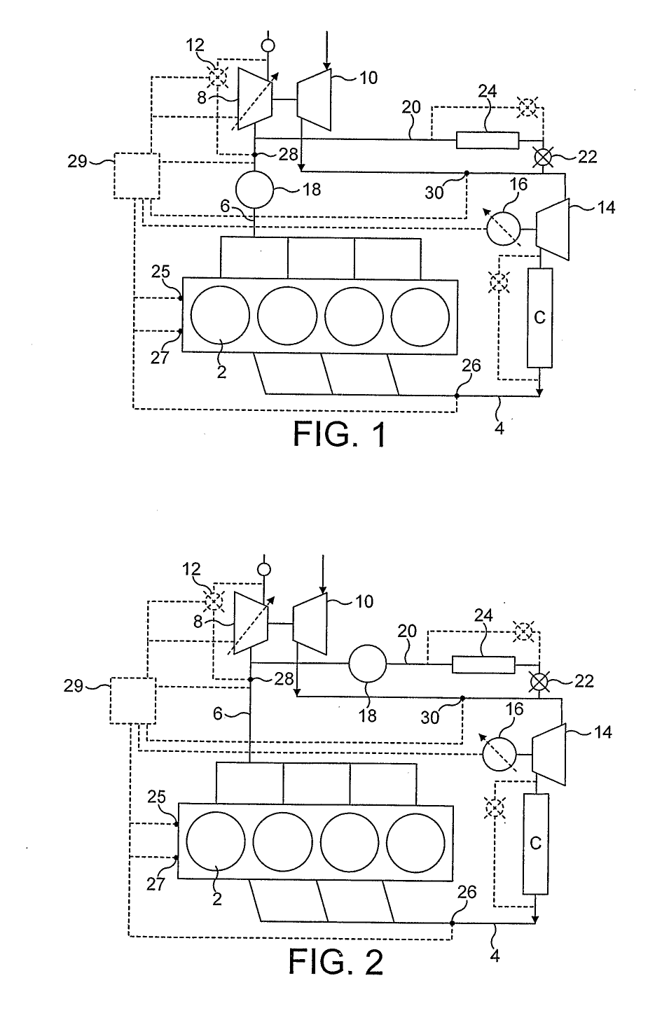

Further features and details of the invention will be apparent from the following description of two specific embodiments of the invention which is given by way of example with reference to FIGS. 1 and 2 of the accompanying drawings which are highly schematic views of two slightly different constructions of a twin-charged diesel engine.

The engine comprises one or more cylinders 2, in this case four cylinders, an inlet duct 4 and an exhaust duct 6. The engine includes a turbocharger of relatively large capacity comprising a turbine wheel 8 situated in the exhaust duct and a compressor wheel 10 coupled to it and situated in the inlet duct. The turbocharger is of adjustable throughput type and for this purpose the blades of the turbine nozzle are of adjustable pitch and/or a wastegate 12 is provided constituting a controllable bypass path around the turbine wheel. The engine further includes a supercharger 14 of relatively small capacity situated in the inlet duct 4 between the compressor wheel 10 and the cylinder(s) 2. The supercharger may be electrically driven but it is preferred that it is mechanically driven, eg. by a belt drive coupled to the engine crankshaft. The supercharger is also of variable throughput type and for this purpose includes a speed controller 16. Situated between the supercharger 14 and the cylinders 2 is a charge air cooler C whose construction and purpose are well known per se.

Situated in the exhaust duct 6 upstream of the turbine wheel 8 is a diesel particulate filter 18 of any appropriate type whose purpose is to remove particulates from the engine exhaust gas. Extending between the exhaust duct 6, at a position between the filter 18 and the turbine wheel 8, and the inlet duct 4, at a position between the compressor wheel 10 and the supercharger 14, is an EGR duct 20, whose purpose is to permit exhaust gas to be recycled and to be admitted into the cylinders mixed with the inlet air. The EGR duct 20 includes a controllable valve 22 and an EGR gas cooler 24 (optionally with a cooler bypass valve), whose construction and purpose are also well known.

Communicating with the inlet duct 4 at a position downstream of the supercharger 14 is a pressure sensor, indicated schematically at 26. Communicating with the exhaust duct 6 at a position upstream of the turbine 8 is a further pressure sensor, indicated schematically at 28. Situated in the inlet duct 4 between the turbine 10 and the supercharger 14 is yet a further pressure sensor, indicated schematically at 30. All of these pressure sensors are connected to a controller 29, which in practice is likely to be part of the engine management system with which most automotive engines are now equipped. Also connected to the controller is the output controller 29 of the turbocharger, namely the wastegate 12 and/or the pitch control for the vanes, and the output controller 16 of the supercharger 14. The engine also includes a load sensor 25 and a speed sensor 27 which are also connected to the controller 29 and are arranged to produce signals indicative of the load and speed of the engine.

In use, the controller 29 calculates from the engine load and speed signals what boost pressure, ie. inlet duct pressure, is desirable and compares this with the actual boost pressure, as indicated by the sensor 26. If a boost pressure different to that currently prevailing is required, the controller adjusts the output of the turbocharger and/or supercharger appropriately. If the engine speed is low and it is desired to increase the boost pressure, the turbocharger is inherently not capable of making any significant contribution to the boost pressure and the controller operates to increase the speed of the supercharger. If the engine speed is relatively high, the controller operates to increase the speed of the turbocharger. However, in order to avoid the exhaust back pressure reaching an excessive level, that is to say a level at which the efficiency of the engine is significantly impaired, the exhaust duct pressure is monitored and compared with a predetermined maximum desired level, and if the exhaust pressure should reach this level and the boost pressure has not reached the desired value, the output of the supercharger is increased and no further increase in the output of the turbocharger is made.

If, generally under light engine load conditions, it is desired to inject exhaust gas into the cylinders, the control system calculates, from a variety of signals including those indicative of the speed and load of the engine, the desired rate of flow of exhaust gas through the EGR duct 20. The engine also includes sensor means indicative of the actual rate of flow of exhaust gas through the duct 20. The sensor means may constitute a flow sensor of known type in the fresh air intake to the turbocharger compressor or in the EGR duct but in this case, the sensor means is constituted by the sensors 28 and 30 because the pressure differential across the ends of the duct 20 can be used to deliver a signal indicative of the flow rate through it. If there is any significant difference between the desired and actual values, the controller alters the speed of the turbocharger and/or supercharger to adjust the pressure differential across the EGR duct to a value which is consistent with the actual value of the flow rate being equal to the desired value.

The modified embodiment shown in FIG. 2 is substantially the same as that in FIG. 1 but the particulate filter has been moved from the exhaust duct to a position in the EGR duct. It will thus perform the same function as regards ensuring that the exhaust gas recirculated to the inlet duct is substantially clean and thus results in no contamination problems. However, in this case, the bulk of the exhaust gas does not pass through the filter and the inefficiency which it would otherwise introduce is therefore substantially eliminated.

1. A diesel engine comprising one or more cylinders, an inlet duct, an exhaust duct, a turbocharger and a supercharger, the turbocharger being of variable output type and including a turbine situated in the exhaust duct and coupled to a compressor wheel situated in the inlet duct, the supercharger being of variable output type and situated in the inlet duct between the compressor wheel and the cylinder(s) and being electrically driven or mechanically driven by the engine, the engine further including a first sensor arranged to produce a signal indicative of the speed of the engine, a second sensor arranged to produce a signal indicative of the load to which the engine is subjected and a third sensor arranged to produce a signal indicative of the pressure in the inlet duct downstream of the supercharger, the sensors being connected to a controller which is also connected to the turbocharger and the supercharger and is arranged to vary their output independently, the controller being programmed to determine the desired value of the pressure in the inlet duct downstream of the supercharger and to compare this with the actual value of the pressure and, in the event of there being a difference, to adjust the output of the supercharger and/or turbocharger until there is substantially no difference, the controller being further programmed, if a higher pressure is required in the inlet duct, to preferentially increase the output of the turbocharger, subject to the pressure in the exhaust duct not exceeding a predetermined value and, if a lower pressure is required in the inlet duct, preferentially to decrease the output of the supercharger.

2. An engine as claimed in claim 1 including an exhaust gas re-circulation (EGR) duct communicating with the exhaust duct at a position between the cylinders and the turbine and with the inlet duct and a gas purifying means situated in the exhaust gas pathway between the cylinders and the position at which the EGR duct communicates with the inlet duct and further including sensor means arranged to produce a signal indicative of the rate of flow of exhaust gas through the EGR duct, the sensor means being connected to the controller, the controller being programmed to determine the desired flow rate of exhaust gas into the inlet duct and to compare this with the actual value of the flow rate and, in the event of there being a difference, to adjust the output of the supercharger and/or turbocharger until there is substantially no difference.

3. An engine as claimed in claim 2 in which the gas purifying means is situated in the exhaust duct upstream of the turbine.

4. An engine as claimed in claim 2 in which the gas purifying means is situated in the EGR duct.

5. An engine as claimed in claim 2 in which the EGR duct communicates with the inlet duct at a position between the compressor wheel and the supercharger.

6. An engine as claimed in claim 1 including a fourth sensor which is connected to the controller and is arranged to produce a signal indicative of the pressure in the exhaust duct upstream of the turbine.

7. An engine as claimed in claim 5 in which the sensor means is constituted by the fourth sensor and by a fifth sensor, which is arranged to produce a signal indicative of the pressure at the downstream end of the EGR duct and is connected to the controller.

8. A method of controlling the operation of a diesel engine comprising one or more cylinders, an inlet duct, an exhaust duct, a turbocharger and a supercharger, the turbocharger being of variable output type and including a turbine situated in the exhaust duct and coupled to a compressor wheel situated in the inlet duct, the supercharger being of variable output type and situated in the inlet duct between the compressor wheel and the cylinder(s) and being electrically driven or mechanically driven by the engine, the method including producing a first signal indicative of the speed of the engine, a second signal indicative of the load to which the engine is subjected and a third signal indicative of the pressure in the inlet duct downstream of the supercharger, processing the first and second signals to produce a further signal indicative of the desired value of the pressure in the inlet duct downstream of the supercharger and comparing this value with the actual value measured by the third sensor and, in the event of there being a difference, adjusting the speed of the supercharger and/or turbocharger until there is substantially no difference, whereby, if a higher pressure is required in the inlet duct, the output of the turbocharger is preferentially increased, subject to the pressure in the exhaust duct not exceeding a predetermined value and, if a lower pressure is acquired in the inlet duct, the output of the supercharger is preferentially decreased.

9. A method as claimed in claim 8 which further includes producing a fourth signal indicative of the pressure in the exhaust duct upstream of the turbine.

10. A method of controlling the operation of a diesel engine as claimed in claim 8 in which the engine further includes an exhaust gas re-circulation (EGR) duct communicating with the exhaust duct at a position between the gas purifying means and the turbine and with the inlet duct and gas purifying means situated in the exhaust gas pathway between the cylinders and the position at which the EGR duct communicates with the inlet duct, the method including processing the first and second signals to produce a signal indicative of the desired rate of flow of exhaust gas through the EGR duct, producing a signal indicative of the actual rate of flow of exhaust gas through the EGR duct, comparing these two signals and, in the event of their being a difference, adjusting the output of the supercharger and/or turbocharger until there is substantially no difference.
